(19) United States
(12) Patent Application Publication
(10) Pub. No.: US 2017/0344806 A1
(43) Pub. Date: Nov. 30, 2017

(54) FACE RECOGNITION SYSTEM AND FACE RECOGNITION METHOD

(71) Applicant: HON HAI PRECISION INDUSTRY CO., LTD., New Taipei (TW)

(72) Inventors: TIEN-PING LIU, New Taipei (TW); I-HAO CHUNG, New Taipei (TW); KUEI-KANG WU, New Taipei (TW)

(21) Appl. No.: 15/361,591

(22) Filed: Nov. 28, 2016

(30) Foreign Application Priority Data
May 27, 2016 (TW) 105116554

(51) Int. Cl. G06K 9/00; G06F 17/30; G06K 9/62

(52) U.S. Cl. CPC G06K 9/00255; G06K 9/6202; G06F 17/30256; G06F 17/3028; G06K 9/00268

(57) ABSTRACT

The disclosure relates to a face recognition system. The face recognition system includes a database module, a camera module, a feature point compare module and a judge module. The database module is configured to store material of a plurality of users. The camera is configured to take a scene-photo of a target person and provide a group of scene-parameters of the scene-photo. The feature point compare module is configured to compare the group of scene-parameters with the material stored in the database. The judge module is configured to compare the scene-photo and the data-photo to judge whether the target person is a user. A face recognition method is also related.

### CROSS-REFERENCE TO RELATED APPLICATIONS

This application claims all benefits accruing under 35 U.S.C. §119 from Taiwan Patent Application No. 105116554, filed on May 27, 2016, in the Taiwan Intellectual Property Office, the contents of which are hereby incorporated by reference.

### FIELD

The subject matter herein generally relates to face recognition systems and face recognition methods, particularly, to face recognition systems and face recognition methods.

### BACKGROUND

Face recognition is a biometric technology which is based on the identification of human face feature information. Face images or video can be captured by the video camera and automatically detected and tracked by face recognition.

With the technology development, face recognition has been applied in many fields, for example, face recognition attendance system, face recognition anti-theft door, face recognition to unlock the phone, face recognition to run with the robot. In a conventional face recognition, camera is used to take data-photos of consumers, and theses data-photos are stored in a database. In use of the face recognition, the camera is used to take a scene-photo of the people, and the scene-photo is compared with the data-photos to judge whether the people is a consumer. However, as the camera parameters of the data-photo and the scene-photo are different from each other, mistake often occurs when comparing the data-photo and the scene-photo.

What is needed, therefore, is to provide a face recognition system and a face recognition method which can overcome the shortcomings as described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a functional diagram of one embodiment of a face recognition system.

FIG. 2 is a flow chart of one embodiment of a face recognition method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The connection can be such that the objects are permanently connected or releasably connected. The term “substantially” is defined to be essentially conforming to the particular dimension, shape or other word that substantially modifies, such that the component need not be exact. The term “comprising” means “including, but not necessarily limited to”; it specifically indicates open-ended inclusion or membership in a so-described combination, group, series and the like. It should be noted that references to “an” or “one” embodiment in this disclosure are not necessarily to the same embodiment, and such references mean at least one.

The present disclosure relates to face recognition systems and face recognition methods described in detail as below.

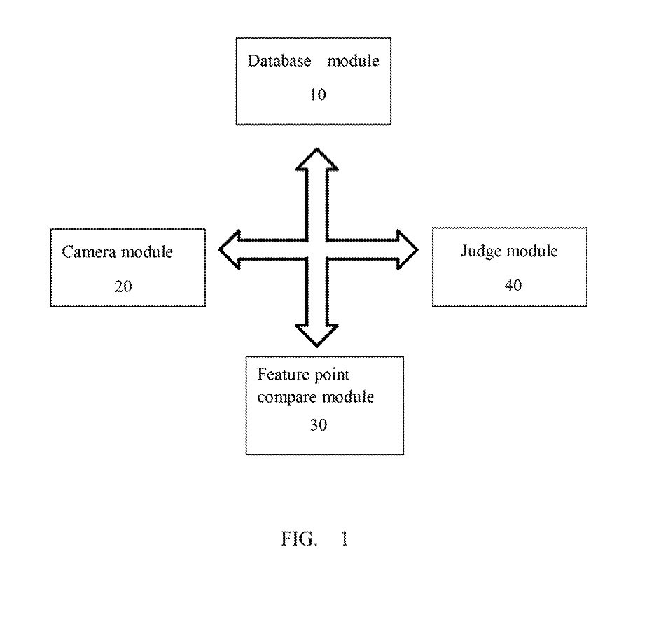

Referring to FIG. 1, a face recognition system 1 of this disclosure is provided. The face recognition system 1 includes a database module 10, a camera module 20, a feature point compare module 30, and a judge module 40. The database module 10 is configured to store material of a plurality of users. Each user has at least two groups of material. Each group of material includes a data-photo of the user and a group of data-parameters of the data-photo. Therefore, database module 10 stores a plurality of data-photos and a plurality groups of data-parameters, and one data-photo corresponds one group of data-parameters. The camera module 20 is configured to take a scene-photo of a target person and provide a group of scene-parameters of the scene-photo. The group of data-parameters or the group of scene-parameters can include at least one of white balance, ISO, diaphragm, shutter, color temperature, pixel, brightness, contrast ratio, time and light. The feature point compare module 30 is configured to compare the group of scene-parameters with the plurality of data-parameters stored in the database module 10 to calculate a group of data-parameter that is most similar with and the groups of scene-parameters, and then choose the data-photo corresponding with the group of data-parameters that is most similar with and the groups of scene-parameters. The judge module 40 is configured to calculate the similar degree of the scene-photo and the data-photo and judge whether they are the same with each other. If the date-photo and the scene-photo are same with each other, the target person is a user. If the date-photo and the scene-photo are different with each other, the target person is a stranger.

The face recognition system 1 includes two kinds of working motions, which are data-collection motion and recognition motion. In data-collection motion of the face recognition system 1, the working process of the face recognition system 1 include:

Ma: the camera module 20 collects material of the plurality of users, which including steps of: taking data-photos of a plurality of users, and providing the plurality of groups of data-parameters of these data-photos; and, sending these date to the database module 10;
Mb: the database module 10 receives the material and stores the material.

In the step Ma, the data-photos are marked as M, the groups of data-parameters are marked as mx, wherein x is the number of the data-parameters in each group of data-parameters, x≧1. Each data-photo M corresponds one group of data-parameters mx.

When the recognition motion of the face recognition system 1 is turn on, the working process of the face recognition system 1 include:

Na: the camera module 20 takes a scene-photo of a target person and provides a group of scene-parameters of the scene-photo;

Nb: the feature point compare module 30 compares the group of scene-parameters with the material of the plurality of users stored in the database module to calculate a group of data-parameters most similar with the group of scene-parameters, and chooses the data-photo corresponding with the group of data-parameters most similar with the group of scene-parameters; and

Nc: the judge module 40 compares the scene-photo with the data-photo corresponding with the group of data-parameters most similar with the group of scene-parameters to judge weather the target person is the user.

In the step Na, the scene-photo is marked as N, the group of scene-parameters is marked as ny, wherein y is the number of the scene-parameters in the group of scene-parameters, y≧1.

In the step Nb, the group scene-parameters and the data-parameters have L same values and K similar values. The K similar values means the K values are different from each other, and the differences is less than 5%.

In the step Nb, in one embodiment, the calculate step includes: calculate L, the greater the L, the more similar the group scene-parameters and the data-parameters. In another embodiment, the calculate step includes: just calculate K, the greater the K, the more similar the group scene-parameters and the data-parameters. In yet another embodiment, the calculate step includes: calculate L and K, if L is greater than K, the greater the L, the more similar the group scene-parameters and the data-parameters; if K is greater than L, the greater the K, the more similar the group scene-parameters and the data-parameters.

In another embodiment, the face recognition system 1 can further includes a modification process. The modification motions is used to modify material of at least one user. The modification process includes steps of: turn on the recognition motion to recognize the at least one user repeatedly in different conditions, choose the condition that the face recognition system 1 cannot recognize the at least one user, and store the scene-photo and the group of scene-parameters in the database module 10.

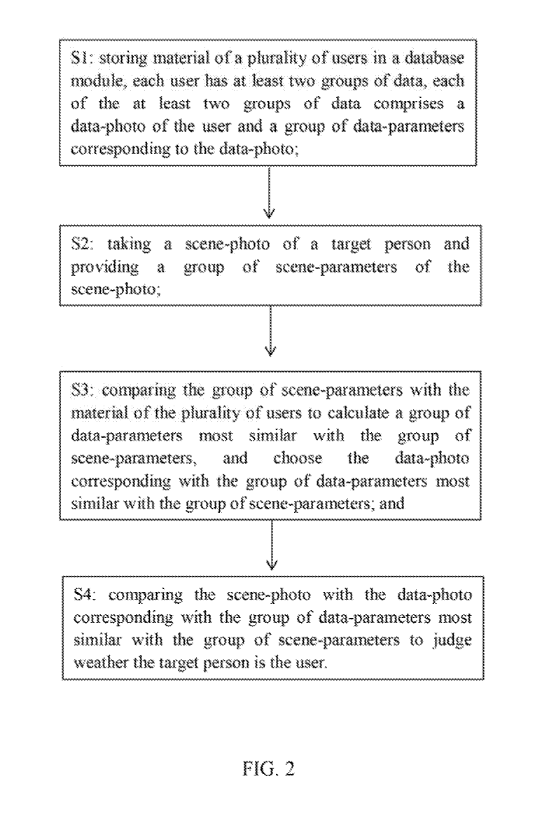

Referring to FIG. 2, a face recognition method is further provided. The method includes the steps of:

S1: storing material of a plurality of users in a database module, each user has at least two groups of material, each group of material includes a data-photo of the user and data-parameters of the data-photo;

S2: taking a scene-photo of a target person and providing a group of scene-parameters of the scene-photo;

S3: comparing the group of scene-parameters with the material of the plurality of users to calculate a group of data-parameters most similar with the group of scene-parameters, and choose the data-photo corresponding with the group of data-parameters most similar with the group of scene-parameters; and

S4: comparing the scene-photo with the data-photo corresponding with the group of data-parameters most similar with the group of scene-parameters to judge weather the target person is the user.

Characteristics of step S3 is the same as step Nb disclosed above.

The face recognition system and the face recognition method are simple and low cost. The face recognition system and face recognition method can be applied in both multi lens or RGBD system and small electric device such as mobile phone. The face recognition system or the face recognition method combine photos and parameters of photos to recognize a target person, and has a high accuracy.

The embodiments shown and described above are only examples. Even though numerous characteristics and advantages of the present technology have been set forth in the forego description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

Depending on the embodiment, certain of the steps of methods described may be removed, others may be added, and the sequence of steps may be altered. The description and the claims drawn to a method may include some indication in reference to certain steps. However, the indication used is only to be viewed for identification purposes and not as a suggestion as to an order for the steps.

What is claimed is:

1. A face recognition system comprising:
a database module configured to store material of a plurality of users, the material of the plurality of users comprises a plurality of data-photos and a plurality of groups of data-parameters;
a camera module configured to take a scene-photo of a target person and provide a group of scene-parameters of the scene-photo;
a feature point compare module configured to compare the group of scene-parameters with the plurality of groups of data-parameters stored in the database module to calculate a group of data-parameters that is most similar with and the group of scene-parameters, and then choose a data-photo corresponding with the group of data-parameters that is most similar with the group of scene-parameters; and
a judge module configured to compare the scene-photo and the data-photo to judge whether the target person is a user.

2. The face recognition system of claim 1, wherein the plurality of data-photos and the plurality of groups of data-parameters corresponds with each other in a one by one manner.

3. The face recognition system of claim 1, wherein each of the plurality of groups of data-parameters or the group of scene-parameters comprises at least one of white balance, ISO, diaphragm, shutter, color temperature, pixel, brightness, contrast ratio, time and light.

4. The face recognition system of claim 1, comprising a data-collection motion and a recognition motion.

5. The face recognition system of claim 4, wherein in the data-collection motion, a working process comprises:
the camera module is configured to take the plurality of data-photos of the plurality of users, provide the plurality of groups of data-parameters of the plurality of data-photos, and send the plurality of data-photos of the plurality of users and the plurality of groups of data-parameters of the plurality of data-photos to the database module;
the database module is configured to receive and store the material of the plurality of users.

6. The face recognition system of claim 4, wherein in the recognition motion, a working process comprises:
the camera module is configured to take the scene-photo of the target person and provide the group of scene-parameters of the scene-photo;
the feature point compare module is configured to compare the group of scene-parameters with the material of the plurality of users stored in the database module to calculate the group of data-parameters most similar with the group of scene-parameters, and choose the data-photo corresponding with the group of data-parameters most similar with the group of scene-parameters; and
the judge module is configured to compare the scene-photo with the data-photo corresponding with the group of data-parameters most similar with the group of scene-parameters to judge weather the target person is the user.

7. The face recognition system of claim 4, further comprising a modification process to modify material of at least one user.

8. A face recognition method, the method comprising the following steps:
S1: storing material of a plurality of users in a database module, each user has at least two groups of data, each of the at least two groups of data comprises a data-photo of the user and a group of data-parameters corresponding to the data-photo;
S2: taking a scene-photo of a target person and providing a group of scene-parameters of the scene-photo;
S3: comparing the group of scene-parameters with the material of the plurality of users to calculate a group of data-parameters most similar with the group of scene-parameters, and choose the data-photo corresponding with the group of data-parameters most similar with the group of scene-parameters; and
S4: comparing the scene-photo with the data-photo corresponding with the group of data-parameters most similar with the group of scene-parameters to judge weather the target person is the user.

9. The method of claim 8, wherein in step S1, the material of a plurality of users comprises a plurality of data-photos and a plurality of groups of data-parameters, the plurality of data-photos is marked as M, the plurality of groups of data-parameters is marked as mx, x is a number of data-parameters in each group of data-parameters, x≧1, each of the plurality of data-photo M corresponds to one group of data-parameters mx.

10. The method of claim 9, wherein in step S2, the scene-photo is marked as N, the group of scene-parameters is marked as ny, wherein y is a number of scene-parameters in the group of scene-parameters, y≧1.

11. The method of claim 10, wherein the group of scene-parameters and the group of data-parameters have L same values and K similar values.

12. The method of claim 10, wherein the K similar values means K values are different from each other, and the differences is less than 5%.

13. The method of claim 11, wherein in step S3, the calculate step comprise: calculate L, the greater the L, the more similar the group of scene-parameters and the group of data-parameters.

14. The method of claim 11, wherein in step S3, the calculate step comprise: calculate K, the greater the K, the more similar the group of scene-parameters and the group of data-parameters.

15. The method of claim 11, wherein in step S3, the calculate step comprises: calculate L and K, L is greater than K, the greater the L, the more similar the group of scene-parameters and the group of data-parameters.

16. The method of claim 11, wherein in step S3, the calculate step comprises: calculate L and K, K is greater than L, the greater the K, the more similar the group of scene-parameters and the group of data-parameters.
